(19) United States
(12) Patent Application Publication
(10) Pub. No.: US 2006/0238299 A1
(43) Pub. Date: Oct. 26, 2006

(54) Electrical enabling device

(76) Inventor: Richard T. Downey, New Westminister (CA)

Correspondence Address: LONG AND CAMERON, SUITE 1401 - 1166 ALBERNI STREET, VANCOUVER, BC, V6E 3Z3, CA

(21) Appl. No.: 11/111,940

(22) Filed: Apr. 22, 2005

(51) Int. Cl. B60R 25/00; B60R 25/10

(52) U.S. Cl. 340/5.72; 340/825.69; 340/426.11

(57) ABSTRACT

There is provided an electrical enabling device that comprises a transmitter for transmitting a control signal, a receiver for receiving the control signal, and a switching apparatus for selectively closing an electrical circuit for a time window to initiate operation of an electrical apparatus in response to the control signal and for opening the electrical circuit after the time window. The switching apparatus is unresponsive to the control signal during the operation of the electrical apparatus.

### BACKGROUND OF THE INVENTION

1. Field of the Invention

The present invention relates to an electrical enabling device for enabling an electrical circuit to operate, and is useful in particular, but not exclusively, to allow electrical circuits in vehicles to operate in order to start the vehicle. The device of the present invention can thus be used as an anti-theft system for vehicles.

2. Description of the Related Art

A conventional electrical enabling device for a vehicle is triggered by an RF signal to enable a vehicle to be started. If, however, the vehicle is not started, the electrical enabling device does not automatically disable the vehicle from being started.

In U.S. Pat. No. 6,265,787 issued on Jul. 24, 2001 to Richard T. Downey, an anti-theft system for a vehicle is disclosed which responds to a remote control to selectively provide power to an ignition coil. Each time the remote control is actuated, the anti-theft system toggles a switch from a previous state to either open or close the switch.

It is a disadvantage of this prior art electrical enabling device that, after the electrical enabling device has enabled the vehicle to be started and the vehicle has not been started, the electrical enabling device does not automatically disable the vehicle from being started after a time period.

It is a further disadvantage of previous electrical enabling devices that, after a vehicle has been started and the vehicle is being operated, the electrical enabling device can toggle the state of a switch, thereby turning off the vehicle. This is potentially hazardous when the vehicle is being driven and the electrical enabling device is disabled by a rogue RF signal.

### BRIEF SUMMARY OF THE INVENTION

It is accordingly an object of the present invention to provide a novel electrical enabling device that enables a vehicle to be started and once started the electrical enabling device can not turn off the vehicle, but rather the vehicle must be turned off in the normal manner to activate the electrical enabling device again.

According to one aspect of the present invention, there is provided an electrical enabling device that comprises a transmitter for transmitting a control signal, a receiver for receiving the control signal, and a switching apparatus for selectively closing an electrical circuit for a time window to initiate operation of an electrical apparatus in response to the control signal and for opening the electrical circuit after the time window. The switching apparatus is unresponsive to the control signal during the operation of the electrical apparatus.

According to a second aspect of the invention, there is provided a combination of a vehicle and an electrical enabling device. The electrical enabling device comprises a transmitter for transmitting a control signal, a receiver for receiving the control signal, and a switching apparatus for selectively closing an electrical circuit for a time window to initiate operation of an electrical apparatus in response to the control signal and for opening the electrical circuit after the time window. The switching apparatus is unresponsive to the control signal during the operation of the electrical apparatus.

According to a third aspect of the present invention, there is provided a method of protecting a vehicle from theft comprising the steps of opening a segment of an electrical circuit in the vehicle, thereby disabling the vehicle from being started, transmitting a control signal to close the segment of the electrical circuit for a time window, thereby enabling the vehicle to be started during the time window, and opening the segment of the electrical circuit if the car is not started during the time window and thereby disabling the vehicle from being started.

According to a fourth aspect of the present invention, there is provided in combination, an electrically enabling device, an electrically operable apparatus and an electrical power source. The electrically enabling device comprises a control signal transmitter, a control signal receiver, a switch between the power source and the electrically operable apparatus a timing circuit between the control signal receiver and the switch, and a latching circuit between the electrically operable apparatus and the switch.

It is an advantage of this invention that, when used with an insured motor vehicle, you can obtain a discount on the motor vehicle insurance. The device of the present invention can be used as an anti-theft deterrent device in motor vehicles.

It is another advantage of this invention to prevent unintentional switch state transitions by disabling the device from responding to rogue RF signals once the electrical apparatus is started. It is yet another advantage of the present invention to provide only a time window in which to initiate operation of the electrical apparatus, thereby preventing unintentional enabling of the electrical apparatus.

### BRIEF DESCRIPTION OF THE DRAWINGS

The present invention will be more readily understood from the following description of preferred embodiments thereof given, by way of example, with reference to the accompanying drawings, in which:

FIG. 1 shows a view in perspective of a vehicle and an electrical enabling device according to an embodiment of the present invention;

FIG. 2 shows a block diagram of the electrical enabling device and an electrical circuit of the vehicle of FIG. 1;

FIG. 3 shows a block diagram view of an electrical enabling device and an electrical circuit of a vehicle according to another embodiment of the present invention;

FIG. 4 shows a block diagram view of an RF transmitter of the electrical enabling device of FIG. 3;

FIG. 5 shows a block diagram view of an electrical enabling device and an electrical circuit of a vehicle according to another embodiment of the present invention; and

FIG. 6 shows a block diagram view of an RF transceiver of the electrical enabling device of FIG. 5.

### DESCRIPTION OF THE PREFERRED EMBODIMENTS

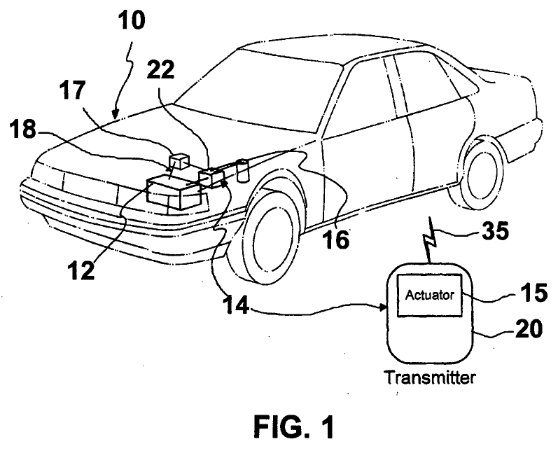

In FIG. 1, there is shown a vehicle indicated generally by reference numeral 10 having a battery 12, an electrical enabling device indicated generally by reference numeral 14, an ignition coil 16 and an ignition coil driver 17. An electrical circuit indicated generally by reference numeral 18 is formed by the battery 12, the electrical enabling device 14, the ignition coil 16, the ignition coil driver 17 and associated electrical connections therebetween. The electrical enabling device 14 forms a segment of the electrical circuit 18.

The electrical enabling device 14 opens the segment of the electrical circuit 18 to disable the ignition coil 16 and ignition coil driver 17 from operating. The electrical enabling device 14 closes the segment of the electrical circuit 18 to enable the ignition coil 16 and ignition coil driver 17 to operate.

In other embodiments of the present invention, the electrical enabling device can enable and disable other electrical circuits in the vehicle 10 from operating, for example, an electronic fuel injection system or an electrical fuel pump.

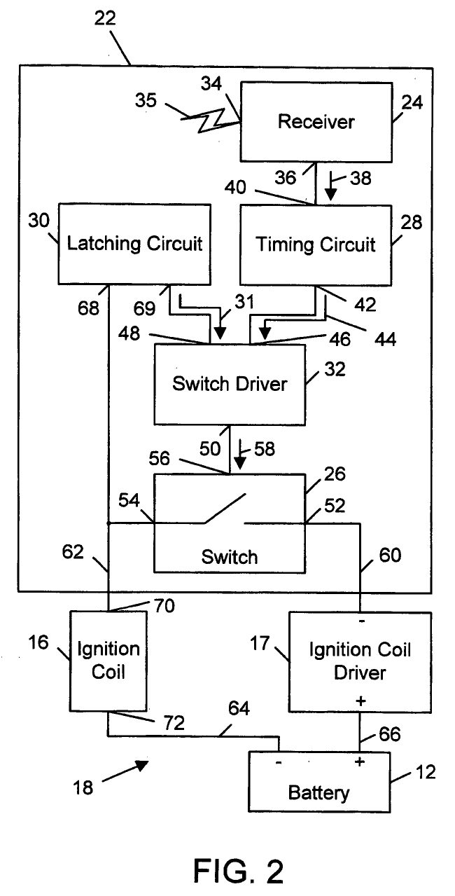

Referring to FIGS. 1 and 2, the electrical enabling device 14 comprises an RF transmitter 20 and an apparatus 22 installed within the vehicle 10. The RF transmitter 20 comprises a button 15 that, when pressed, actuates the transmitter to emit an RF control signal 35. The apparatus 22 comprises an RF receiver 24, a switch 26, a timing circuit 28, a latching circuit 30 and a switch driver 32.

The RF receiver 24 has an input 34 and an output 36. The input 34 receives the RF control signal 35 from the RF transmitter 20. The output 36 is connected to the timing circuit 28. The RF receiver 24 is responsive to the RF control signal 35 and provides an electrical control signal 38 at the output 36.

The RF receiver 24 is programmed to operate with one or more of the RF transmitters 20. The RF receiver 24 is only responsive to the RF transmitters 20 that have been programmed to operate with the particular RF receiver 24. If one of the RF transmitters 20 is lost or stolen, the RF receiver can be programmed to no longer operate with that particular RF transmitter 20.

The RF receiver 24 is placed into program mode by actuating a button (not shown) on the RF receiver, and stays in program mode for a set time period. During the program mode time period, any RF transmitter 20 that is actuated within range of the RF receiver 24 will be programmed to operate with the RF receiver. During normal operation, the RF receiver 24 makes a clicking noise when an RF transmitter 20 that has programmed for that RF receiver is actuated.

The timing circuit 28 has an input 40, and an output 42. The input 40 is connected to the output 36 of the receiver 24 and receives the control signal 38. The output 42 is connected to the switch driver circuit 32. The timing circuit 28 is responsive to the control signal 38 and provides a one-shot switch signal 44 at the output 42.

The switch driver circuit 32 has a first input 46, a second input 48 and an output 50. The first input 46 is connected to the output 42 of the timing circuit 28 and receives the one-shot switch signal 44. The output 50 is connected to the switch 26. The switch driver circuit 32 is responsive to the one-shot switch signal 44 and provides a switch control signal 58 at the output 50.

The switch 26 comprises an electromechanical relay (not shown) in this example. In other embodiments, the switch 26 can comprise, for example and without limitation, a solid state relay, a solid state switch or a self-latching relay. The switch 26 has a first switch terminal 52, a second switch terminal 54 and a switch control input 56. The switch control input 56 is connected to the output 50 of the switch driver circuit 32 and receives the switch control signal 58.

Normally, the switch 26, between the first and second switch terminals 52 and 54, is open and no electrical energy can flow between these terminals. When the switch control signal 58 is applied to the switch control input 56, the switch 26 closes allowing electrical energy to flow between the terminals 52 and 54.

The first switch terminal 52 is connected to a negative terminal on the ignition coil driver 17 by electrical connection 60. The second switch terminal 54 is connected to a first terminal 70 on the ignition coil 16 by electrical connection 62. A positive terminal on the ignition coil driver 17 is connected to a positive terminal on the battery 12 by electrical connection 66. A terminal 72 on the ignition coil 16 is connected to a negative terminal on the battery 12 by electrical connection 64. The battery 12, the ignition coil driver 17, the switch 26, the ignition coil 16 and the electrical connections 60, 62, 64 and 66 form the electrical circuit 18.

The latching circuit 30 comprises an input 68 and an output 69. The input 68 is connected to the second switch terminal 54 and the output 69 is connected to the second input 48 of the switch driver circuit 32. The latching circuit 30 is responsive to electrical energy at input 68 and provides a latching signal 31 to the second input 48 of the switch driver circuit 32. The switch driver circuit 32 is further responsive to the latching signal 31, in addition to the one-shot signal 44, to provide the switch control signal 58.

In operation the vehicle 10 is initially inoperative and the switch 26 is open. A vehicle operator actuates the transmitter 20 by pressing the button 15 and the transmitter 20 emits the control signal 35. The receiver 24 receives the control signal 35 and provides the electrical signal 38 to the timing circuit 28. The timing circuit 28 in response provides the one-shot signal 44 to the switch driver 32. The switch driver 32 in response provides the switch control signal 58 which enables the switch 26 by closing the circuit between the first and second switch terminals 52 and 54.

The switch control signal 58 is applied to the switch 26 as long as the one-shot signal 44 or the latching signal 31 is applied to the switch driver 32. The one-shot signal 44 is a pulse that has a pulse width determined by the timing circuit 28. In this example, the pulse width of the one-shot signal 44 is 60 seconds, but in other examples the pulse width can be set for other time periods. The one-shot signal 44 therefore provides a time window for the vehicle operator to start the vehicle.

During the time window when the circuit between the first and second switch terminals 52 and 54 is closed, the switch 26 is enabled and the vehicle operator can turn an ignition key and the vehicle 10 will start. If the vehicle is not started during the time window, the switch driver circuit 32 disables the switch 26 by removing the switch control signal 58. In this situation, the vehicle operator must press the button 15 on the RF transmitter 20 to enable the switch 26 again.

If the ignition key is turned on during the time window ofthe pulse, the ignition coil driver 17 will provide electrical energy through the switch 26 to the ignition coil 16, which then provides the electrical energy to a distributor (not shown) in order to start the vehicle. The latching circuit 30 senses the electrical energy at input 68 and provides the latching signal 31 to the switch driver 32. In this situation, after the time window is over, and the one-shot signal 44 is removed from the switch driver circuit 32, the latching signal 31 is still present and the switch driver circuit 32 still provides the switch control signal 58 to the switch 26.

Once the vehicle is started, pressing the button 15 on the transmitter 20 has no further effect on the operation of the vehicle since the latching signal 31 maintains the switch 26 closed. Only when the vehicle is turned off by turning off the ignition key will the electrical energy stop flowing through the switch 26, at which point the latching circuit 30 no longer senses the electrical energy and removes the latching signal 31 from the switch driver circuit 26 thereby opening the switch 26. At this point the electrical enabling device 14 prevents the vehicle from starting without the button 15 on the transmitter 20 firstly being pressed by the operator.

It is understood that in other embodiments of the present invention, the switch 26 of the electrical enabling device 14 can form a segment of the connection 64 or a segment of the connection 66, and the latching circuit 30 would accordingly sense electrical energy through the switch 26, e.g. by sensing an electrical current.

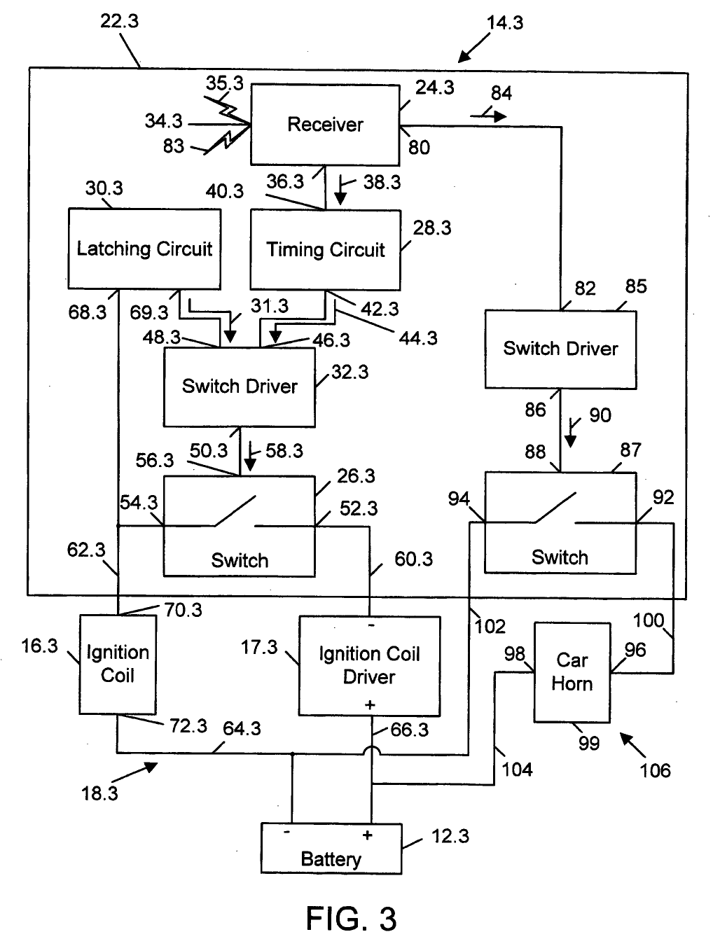

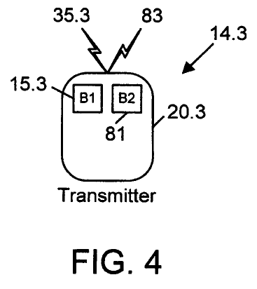

Referring now to FIGS. 3 and 4, in another embodiment of the present invention, wherein like parts to the previous embodiment have like reference numerals with an additional suffix “0.3”, there is an electrical enabling device indicated generally by reference numeral 14.3 comprising an RF transmitter 20.3 and an apparatus 22.3.

The RF transmitter 20.3 is similar to the previous RF transmitter 20 and further includes a button 81 that when actuated generates RF signal 83. Button 15.3 of the RF transmitter 20.3 when actuated generates RF signal 35.3

The apparatus 22.3 includes an RF receiver 24.3 similar to the RF receiver 24, and which further includes an output 80. Input 34.3 of the RF receiver 24.3 is responsive to both RF signals 35.3 and 83. When the input 34.3 receives the RF signal 35.3 the RF receiver 24.3 produces signal 38.3 at output 36.3. When the input 34.3 receives the RF signal 83 the RF receiver 24.3 produces control signal 84 at the output 80.

The apparatus 22.3 is similar to the apparatus 22 and further includes a switch driver circuit 85 and a switch 87. The switch driver circuit 85 comprises an input 82 and an output 86. The input 82 is connected to the output 80 of the RF receiver 24.3 and receives the control signal 84. The output 86 is connected to the switch 87. The switch driver circuit 85 is responsive to the control signal 84 and provides a switch control signal 90 at the output 86.

The switch 87 comprises an electromechanical relay (not shown) in this example and has a first switch terminal 92, a second switch terminal 94 and a switch control input 88. The switch control input 88 is connected to the output 86 of the switch driver circuit 85 and receives the switch control signal 90.

Normally, the switch 87, between the first and second switch terminals 92 and 94, is open and no electrical energy can flow between these terminals. When the switch control signal 90 is applied to the switch control input 88, the switch 87 closes allowing electrical energy to flow between the terminals 92 and 94.

The first switch terminal 92 is connected to a terminal 96 on a car horn 99 by connection 100. The second switch terminal 94 is connected to a negative terminal on battery 12 by connection 102. A terminal 98 on the car horn 99 is connected to a positive terminal on the battery 12 by connection 104. The battery 12, the car horn 99, the switch 87 and the electrical connections 100, 102, and 104 form an electrical circuit indicated generally by reference numeral 106.

In operation, when a user actuates button 81 the electrical circuit 106 closes and the car horn sounds. The car horn sounds as long as the button 81 is actuated.

The ability to sound the car horn is advantageous to scare intruders away from your vehicle without having to approach the vehicle itself. In another situation, if a vehicle operator is confronted outside their vehicle and is in fear, they can simply actuate the button 81 to sound the car horn in order to attract attention. In another useful application, if the vehicle operator can not locate their vehicle, e.g. within a parking lot, they can simple actuate button 81 on the RF transmitter 20.3 to sound the car horn in order to give them an indication of where the vehicle is located.

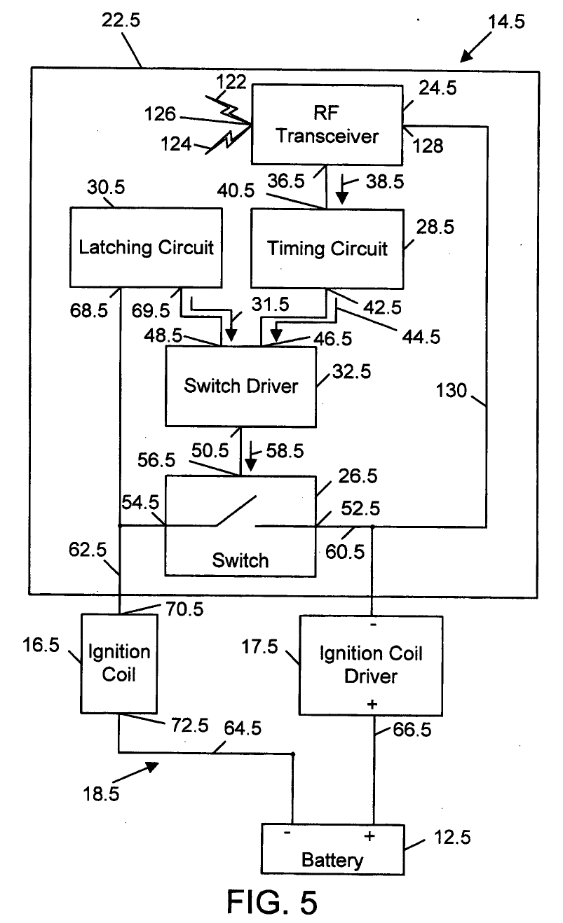

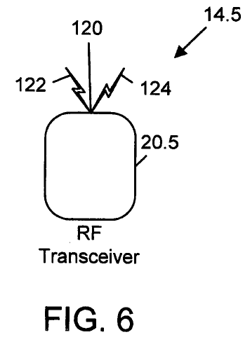

Referring now to FIGS. 5 and 6, in another embodiment of the present invention, wherein like parts to the previous embodiments have like reference numerals with an additional suffix “0.5”, there is an electrical enabling device indicated generally by reference numeral 14.5 comprising an RF transceiver 20.5 and an apparatus 22.5.

The RF transceiver 20.5 comprises an RF receiver (not shown), an RF transmitter (not shown) and a bidirectional RF port 120. The RF transceiver 20.5 receives an RF signal 122 at the port 120 and transmits an RF signal 124 therefrom.

The apparatus 22.5 is similar to the apparatuses 22 and 22.3 and instead of the RF receivers 24 and 24.5 the apparatus 22.5 includes an RF transceiver 24.5 having a bi-directional RF port 126, an output port 36.5 and a power port 128. The RF transceiver 24.5 transmits the RF signal 122 from the RF port 126 and receives the RF signal 124 at the RF port 126. The power port 128 is connected to a negative terminal on an ignition coil driver 17.5 by connection 130. The output port 36.5 operates substantially the same as the outputs 36 and 36.3.

In operation, the electrical enabling device 14.5 is used to enable and disable the operation of an ignition circuit in a vehicle. In order for an operator to initiate operation of the vehicle they insert a key into the ignition and turn the key to start as is normally done. Turning the key enables the ignition coil driver 17.5 which then provides electrical energy to the RF transceiver 24.5.

Upon being energized, the RF transceiver 24.5 transmits the RF signal 122, which is encoded, to the RF transceiver 20.5, which receives and decodes the signal 122. Normally the RF transceiver 20.5 is attached to the key and is therefore within range. The RF transceiver 20.5 must be in the range of the RF transceiver 24.5 and vice versa.

If the decoded signal 122 is correct then the RF transceiver 20.5 transmits the RF signal 124, which is also encoded, to the RF transceiver 24.5, which then receives and decodes the signal 124. If the decoded signal 124 is correct then the RF transceiver outputs an electrical control signal 38.5. The operation of apparatus 22.5 following the output of the electrical control signal 38.5 is similar to that described in previous embodiments.

When the key is removed from the ignition the ignition coil driver 17.5 is disabled and the electrical energy is removed from latching circuit 30.5 and the RF transceiver 24.5 and the vehicle therefore turns off. In order to start the vehicle again the above procedure must be repeated.

As will be apparent to those skilled in the art, various other modifications may be made to the above described invention within the scope of the appended claims.

What is claimed is:

1. An electrical enabling device comprising:
a transmitter means for transmitting a first control signal;
a receiver means for receiving the first control signal; and
a first switching means for selectively closing a first electrical circuit for a time window to initiate operation of a first electrical apparatus in response to the receiver receiving the first control signal and for opening the first electrical circuit after the time window, said first switching means being unresponsive to the first control signal during the operation of the first electrical apparatus.

2. The electrical enabling device of claim 1, wherein the first switching means comprises:
a switch driver;
a switch responsive to the switch driver;
a timing circuit responsive to the first control signal from the receiver means and providing a switch signal to the switch driver during the time window; and
a latching circuit responsive to a supply of electrical energy through the first electrical circuit to provide a latching signal to the switch driver;
the switch driver being responsive to the switch signal and the latching signal to activate the switch to close the first electrical circuit when the switch signal or the latch signal are applied to the switch driver.

3. The electrical enabling device of claim 2, wherein the switch comprises an electro-mechanical relay.

4. The electrical enabling device of claim 2, wherein the switch comprises a solid-state relay.

5. The electrical enabling device of claim 2, wherein the switch comprises a solid state switch.

6. The electrical enabling device of claim 5, wherein the solid state switch comprises a MOSFET device.

7. The electrical enabling device of claim 2, wherein the timing circuit comprises a multivibrator circuit responsive to the first control signal and configured to generate the switch signal as a one-shot signal.

8. The electrical enabling device of claim 2, wherein the latching circuit comprises a resistor and a capacitor, the resistor being responsive to an electrical signal from the first switching means to store a charge on the capacitor and the charge on the capacitor providing the latching signal.

9. The electrical enabling device of claim 1, wherein the first switching means comprises:
a self-latching relay having a first relay terminal, a second relay terminal and a relay control input, the segment of the first electrical circuit being between the first relay terminal and the second relay terminal; and
said electrical enabling device including a timing circuit responsive to the first control signal from the receiver means to provide a relay signal during the time window and the relay control input being responsive to the relay signal to short the first relay terminal to the second relay terminal and to thereby close the first electrical circuit.

10. The electrical enabling device of claim 1, wherein the transmitter means is an RF transmitter.

11. The electrical enabling device of claim 2, wherein the receiver means is an RF receiver.

12. The electrical enabling device of claim 1, wherein the receiver means is programmed to operate with the transmitter means.

13. The electrical enabling device of claim 1, wherein the transmitter means transmits a second control signal and the receiver means receives the second control signal, and wherein the device further includes a second switching means for selectively closing a second electrical circuit to operate a second electrical apparatus in response to the receiver receiving the second control signal, the second switching means opening the second electrical circuit when the receiver means stops receiving the second control signal.

14. The electrical enabling device of claim 13, wherein the second switching means comprises:
a switch driver;
a switch responsive to the switch driver;
the switch driver being responsive to the second control signal to activate the switch to close the second electrical circuit when the second control signal is applied to the switch driver.

15. The electrical enabling device of claim 13, wherein the second electrical apparatus comprises a car horn.

16. The electrical enabling device of claim 1, wherein the transmitter means comprises a first RF transmitter for transmitting the first control signal and a first RF receiver for receiving a second control signal, and wherein the receiver means comprises a second RF receiver for receiving the first control signal and a second RF transmitter for transmitting the second control signal, the receiver means transmitting the second control signal when the first electrical apparatus is operated and the transmitter means transmitting the first control signal to the receiver means upon receiving the second control signal.

17. In combination, an electrically enabling device, an electrically operable apparatus and an electrical power source, the electrically enabling device comprising:
a control signal transmitter;
a control signal receiver;
a switch between the power source and the electrically operable apparatus;
a timing circuit between the control signal receiver and the switch; and
a latching circuit between the electrically operable apparatus and the switch.

18. A method of protecting a vehicle from theft comprising the steps:
opening a segment of an electrical circuit in the vehicle, thereby disabling the vehicle from being started;
transmitting a control signal to close the segment of the electrical circuit for a time window, thereby enabling the vehicle to be started during the time window; and
opening the segment of the electrical circuit if the car is not started during the time window and thereby disabling the vehicle from being started.

19. The method of claim 18, including the step, after the vehicle is started, of disabling the ability of the control signal from the transmitter from opening the segment of the electrical circuit thereby turning off the vehicle.

20. The method of claim 19, wherein the method further includes the steps of:
opening the segment of the electrical circuit after the vehicle is turned off; and
enabling the ability of the control signal from the transmitter to close the segment of the electrical circuit thereby enabling the vehicle to be started.
